(19) United States
(12) Patent Application Publication
(10) Pub. No.: US 2026/0126963 A1
(43) Pub. Date: May 7, 2026

(54) WEB BROWSER-BASED DESIGN OF EMBEDDED HARDWARE SYSTEMS

(71) Applicant: Renesas Electronics America Inc., Milpitas, CA (US)

(72) Inventors: Rajkumar THIAGARAJAN, San Ramon, CA (US); Dhananjay Kumar SINGH, San Jose, CA (US); Vinay Venkatesh MALEKAL, Santa Clara, CA (US)

(73) Assignee: Renesas Electronics America Inc., Milpitas, CA (US)

(21) Appl. No.: 19/348,175

(22) Filed: Oct. 2, 2025

Related U.S. Application Data
(60) Provisional application No. 63/716,954, filed on Nov. 6, 2024.

(51) Int. Cl. G06F 8/34; H04L 67/02

(52) U.S. Cl. CPC G06F 8/34; H04L 67/02

(57) ABSTRACT

A design system includes a server in communication with a host device. The server is configured to obtain a compatibility request to perform a compatibility analysis from a design interface presented to a user of the host device by a web browser of the host device. The compatibility request includes design information corresponding to a plurality of blocks of an embedded hardware system design. The server is configured to execute the compatibility analysis based on the design information and a compatibility matrix including compatibility information for each of the plurality of blocks, determine that a given block of the plurality of blocks is not compatible with at least one other block of the plurality of blocks based on the compatibility analysis and transmit a response to the host device. The response includes an indication that the given block is not compatible with the at least one other block.

### CROSS REFERENCE TO RELATED APPLICATION

This application claims the benefit of U.S. Provisional Patent Application No. 63/716,954, entitled “QuickConnect Docking,” filed on November 6, 2024, the entirety of which is incorporated by reference herein.

### BACKGROUND

The present disclosure relates in general to embedded systems. More specifically, the present disclosure relates to a web browser-based design of embedded hardware systems.

Embedded system designers often face challenges when attempting to design system solutions on various hardware platforms. Different hardware components and software configurations can create compatibility issues that may lead to software malfunctions or system crashes.

Historically, identifying hardware and software compatibility has been performed through manual checks by system designers or subject matter experts using tools that are typically limited in scope or require the installation of additional software. These tools may not be accessible to all users due to technical complexity or may only work on specific operating systems or devices, which limit their utility. This manual approach can be time-consuming and flawed due to human error.

### SUMMARY

In one embodiment, a design system is disclosed. The design system comprises a server in communication with a host device. The server is configured to obtain a compatibility request to perform a compatibility analysis from a design interface presented to a user of the host device by a web browser of the host device. The compatibility request comprises design information corresponding to a plurality of blocks of an embedded hardware system design. The server is configured to execute the compatibility analysis based on the design information and a compatibility matrix comprising compatibility information for each of the plurality of blocks, determine that a given block of the plurality of blocks is not compatible with at least one other block of the plurality of blocks based on the compatibility analysis and transmit a response to the host device. The response comprises an indication that the given block is not compatible with the at least one other block.

In one embodiment, a method is disclosed. The method comprises obtaining a compatibility request to perform a compatibility analysis from a design interface presented to a user of a host device by a web browser of the host device. The compatibility request comprises design information corresponding to a plurality of blocks of an embedded hardware system design. The method further includes executing the compatibility analysis based on the design information and a compatibility matrix comprising compatibility information for each of the plurality of blocks, determining that a given block of the plurality of blocks is not compatible with at least one other block of the plurality of blocks based on the compatibility analysis and transmitting a response to the host device. The response comprises an indication that the given block is not compatible with the at least one other block.

In one embodiment, an apparatus is disclosed. The apparatus includes a display device, an input device, and a user interface configured for presentation on the display device. The user interface comprises a web browser. The web browser is configured to present a design interface comprising an embedded hardware system design to a user of the apparatus. The web browser is configured to determine that a given block has been added to a plurality of blocks of the embedded hardware system design and automatically submit a compatibility request to a server to perform a compatibility analysis. The compatibility request comprises design information corresponding to the plurality of blocks of the embedded hardware system design. The web browser is further configured to obtain a response from the server comprising an indication that the given block is not compatible with at least one other block of the plurality of blocks of the embedded hardware system design and present, in the design interface, a compatibility warning indicating that the given block is not compatible with the at least one other block of the plurality of blocks of the embedded hardware system design.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 is a block diagram illustrating an example design system according to an embodiment.

FIGS. 1-6 are block diagrams illustrating an example debug interface of the design system of FIG. 1 according to an embodiment.

FIG. 7 is a flowchart illustrating an example design logic process according to an embodiment.

### DETAILED DESCRIPTION

The availability of web technologies has led to increased demand for browser-based solutions that do not require the installation of separate software applications. A browser-based compatibility check system has the potential to streamline the design process by offering real-time assessments and recommendations on embedded system design that is accessible from any device with an internet connection without the need to install additional software.

The disclosed embodiments address the limitations of existing compatibility-checking methods by introducing a web browser-based system that performs automated real-time compatibility checks of both hardware and software for an embedded hardware system design. The browser-based system offers users an accessible and reliable tool for ensuring embedded system compatibility with minimal effort and no need to install additional software, plugins or other functionality on their device to perform system design for embedded hardware.

The present disclosure introduces a system and method for performing hardware and software compatibility checks for embedded hardware system designs in a web browser. The web browser-based system automatically determines and analyses a user’s selected hardware components (such, e.g., as processors, memory, etc.) and software components (such as, e.g., operating systems, drivers, stacks, etc.) of an embedded hardware system design for compatibility. By employing a web browser-based design tool with automatic compatibility checking, the requirement to install any additional software on a user’s computer is mitigated or entirely removed.

As an example, an embodiment of the web browser-based design system enables real-time analysis that includes comparing detected system information with a compatibility matrix or database that contains system requirements for various software or hardware design blocks. The system also produces a detailed report for the user, highlighting incompatibility issues as well as recommendations on how to fix them if necessary, e.g., by using a different hardware or software block or a different configuration.

The web browser-based design provides cross-platform capabilities that support all kinds of operating systems, devices, and browsers. This enables users, no matter how tech-savvy, to know at a glance if their embedded hardware system design meets the requirements for a particular application or hardware change. The system also provides remote diagnostics and troubleshooting, making it useful for end users.

The disclosed embodiments enable the process of compatibility checking and onboarding of new embedded hardware system designs to be simpler and less prone to errors, easier for users to perform and brings greater accessibility to system diagnostics with an easy-to-access browser-based experience.

### Example Design System

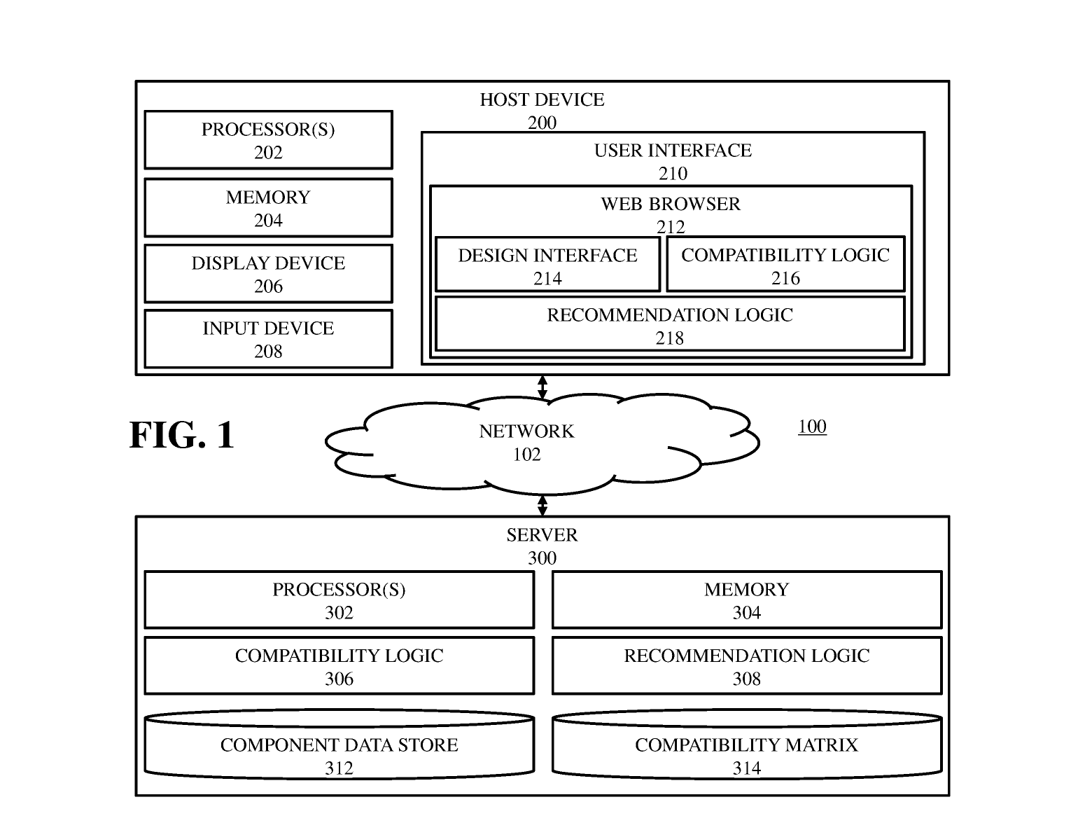

With reference to FIG. 1, an example design system 100 is described according to an embodiment. Design system 100 comprises a network 102, a host device 200 and a server 300. Design system 100 may be utilized to facilitate the design of embedded hardware systems.

As described herein, the term “real-time” includes the time that it takes for communications between host device 200 and server 300 and processing performed by host device 200 and server 300 as needed to generate transmit and present a compatibility warning and recommendations to a user of host device 200. In an embodiment, the term “real-time” as used herein may comprise milliseconds, seconds, or even minutes, depending on the complexity of the embedded hardware system design being analyzed for compatibility and recommendations.

Network 102 is configured to connect host device 200 with server 300 and comprises one or more wired, wireless or combined wired/wireless networks and corresponding hardware such as hubs, switches, access points, network interfaces or other hardware commonly found in a network. Example wired and wireless networks that may be utilized include the Internet, a wide area network (WAN), a local area network (LAN), satellite, telephone, cable, a fiber-optic, cellular, ethernet, WiFi, WiMAX, Bluetooth®, any other network or connection or any combination thereof.

Design system 100 may be designed with a strong emphasis on security and user privacy. For example, in some embodiments, no personally identifiable information or sensitive data may be collected during a compatibility check and transmitted between host device 200 and server 300 via network 102. Design system 100 may be configured to only collect hardware and software configuration data about an embedded hardware system design that is necessary for determining the compatibility of the various hardware or software components in that design. Data transmission between host device 200 and server 300 may be encrypted, e.g., using industry-standard protocols such as SSL/TLS or other protocols.

In another embodiment, the user of host device 200 may be provided with an option to control over what type of data is being shared with design system 100. As an example, the user may choose only enable compatibility checks for part of their embedded hardware system design, e.g., focusing only on specific aspects or components of their system.

Host device 200 comprises one or more processors 202, memory 204, a display device 206, an input device 208 and a user interface 210.

Processor(s) 202 comprise, e.g., a processor, a microprocessor, a microcontroller, an application-specific integrated circuit (ASIC), a field-programmable gate array (FPGA), a graphics processing unit (GPU), a printed circuit board (PCB) or any other type of processing circuitry, as well as portions or combinations of such circuitry elements.

Memory 204 comprises, e.g., random access memory (RAM), read-only memory (ROM), flash memory or other types of memory, in any combination. The memory and other memories disclosed herein should be viewed as illustrative examples of what are more generally referred to as “processor-readable storage media” storing executable program code of one or more software programs.

Display device 206 comprises, e.g., a screen, a monitor, a television, phone, smart device, or any other device that is configured to present data or images to a user.

Input device 208 comprises, e.g., a keyboard, mouse, touch screen, or any other physical interface that is configured to receive a user input from a user.

User interface 210 comprises an interactive graphical user interface that may be presented to a user, e.g., via display device 206. The user may interact with user interface 210 using input device 208 to cause an execution of functionality on host device 200. For example, in an embodiment, user interface 210 comprises a web browser 212.

Web browser 212, e.g., Chrome, Edge, Safari, Mozilla, a custom web browser or any other web browser, is configured to present a design interface 214 to a user of host device 200. As an example, web browser 212 may be utilized by the user to log into a website, e.g., using a uniform resource locator (URL) that causes web browser 212 to present design interface 214 in some embodiments. As an example, web browser 212 may initiate a request for content by transmitting a Hypertext Transfer Protocol (HTTP) request to server 300, where the request identifies a design interface 214 using the corresponding URL. Server 300, having received the request at the corresponding URL, is configured to retrieve the requested content, e.g., debug interface 214, and transmit a response to web browser 212 containing design interface 214 for presentation on web browser 212.

In some embodiments, design interface 214 is configured for presentation by web browser 212 without the need to install any other software on host device 200, e.g., can be accessed and used by any device having a web browser 212 as a normal web page. In other embodiments, design interface 214 may be part of web browser 212, a plugin to web browser 212 or otherwise be presented in conjunction with web browser 212 in any other manner.

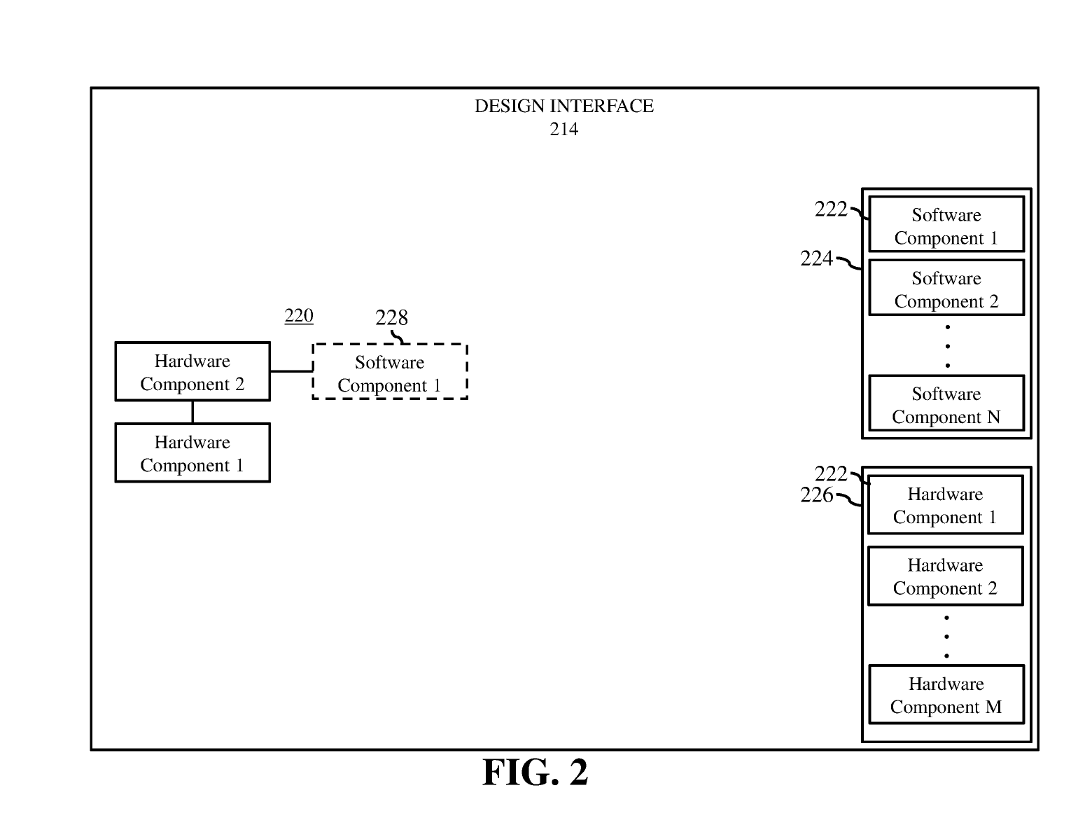

Design interface 214 enables the user of host device 200 to create an embedded hardware system design 220. For example, design interface 214 may present a user of host device 200 with various blocks 222 of software components 224, e.g., software component 1, software component 2, . . . software component N, and hardware components 226, e.g., hardware component 1, hardware component 2, . . . hardware component M, that can be positioned within design interface 214 and associated with one another to form an embedded hardware system design 220. An embodiment of a non-limiting example design interface 214 of web browser 212 is shown in FIGS. 2-6.

For example, as shown in FIG. 2, hardware component 1 and hardware component 2 were both previously added to embedded hardware system design 220 by a user of host device 200 and software component 1 is being added as a newly added block 228 which is denoted with dashed lines.

Design interface 214 is configured for cross-platform use and may be utilized in any web browser 212 or other interface in which a user may access a web site or server. In some embodiments, for example, design interface 214 may be configured to utilize widely supported web standards such as, e.g., TypeScript, JavaScript, WebAssembly or other web standards common to web browsers 212. As an example, TypeScript may be written to make a call out to query the web browser 212’s built-in APIs and gather information about the embedded hardware system design 220 without the need for elevated permissions or external software installation.

Design interface 214 is also configured to support cross-platform compatibility, ensuring that it can operate on host devices 200 having different operating systems, e.g., Windows, macOS, Linux or other operating systems, and across various browsers, e.g., Chrome, Firefox, Safari or other web browsers. Design interface 214 may be configured to serialize and transmit data about embedded hardware system design 220 securely to server 300 for analysis.

In conjunction with design interface 214, web browser 212 is also configured to execute compatibility logic 216 and recommendation logic 218 locally on host device 200, in conjunction with an execution of corresponding compatibility logic 306 and recommendation logic 308 on server 300, or both.

Compatibility logic 216 is configured to automatically determine the compatibility of a newly added block 228 that is added to embedded hardware system design 220 by a user of host device 200. Compatibility logic 216 may be configured to run in the background without the user’s awareness in some embodiments.

Compatibility logic 216 is configured to obtain information about embedded hardware system design 220 including which hardware and software blocks 222 are part of embedded hardware system design 220, information about newly added block 228 and information about how all of the blocks 222 in embedded hardware system design 220 are configured together. Compatibility logic 216 uses this information to make a determination on the compatibility of the blocks 222 in embedded hardware system design 220 and the compatibility of any newly added block 228, either within web browser 212 or using compatibility logic 306 of server 300.

In some embodiments, web browser 212 may include block related compatibility information for some or all of the available blocks 222 of software components and hardware components, e.g., pre-downloaded and cashed by web browser 212 for use in the current design session using design interface 214, that may be utilized by compatibility logic 216 to determine the compatibility of newly added block 228 to embedded hardware system design 220. In some embodiments, only the most commonly used blocks may have corresponding compatibility information pre-downloaded and compatibility logic 216 may be configured to communicate with corresponding compatibility logic 306 of server 300 to perform a compatibility determination for any other blocks. In some embodiments, compatibility logic 216 may be configured to communicate with compatibility logic 306 of server 300 to perform a compatibility determination for each newly added block 228.

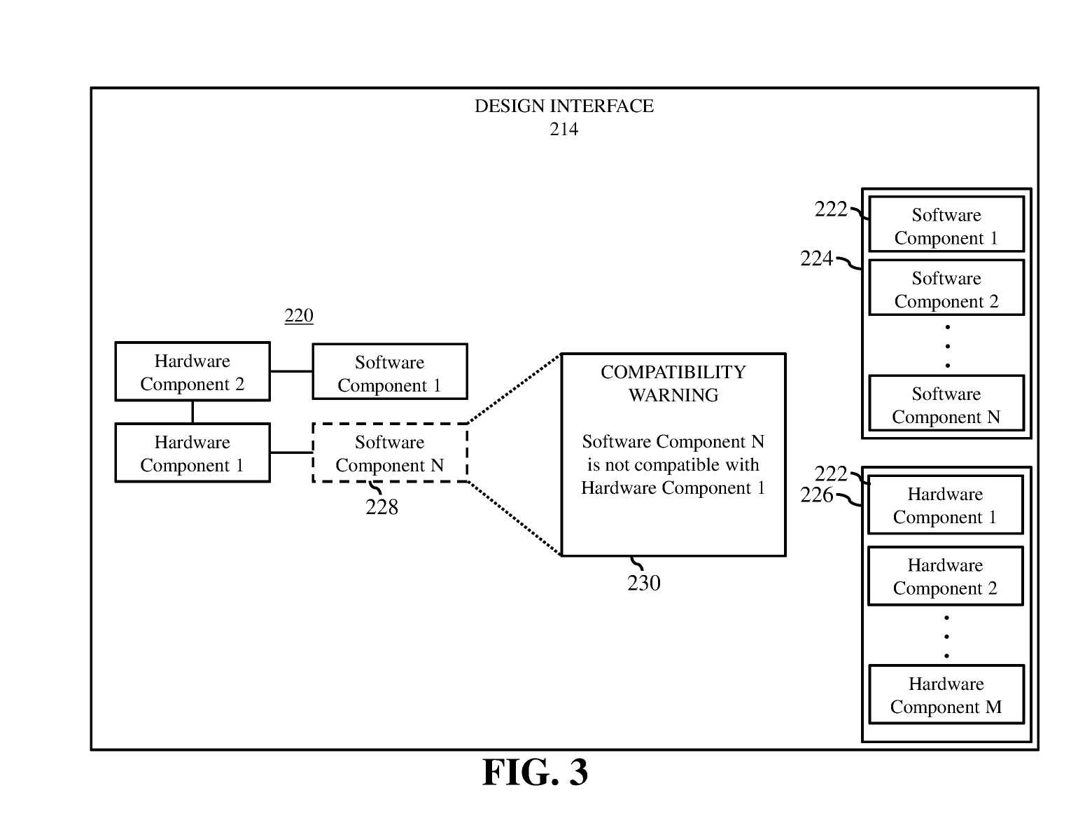

In a case where newly added block 228 is compatible with embedded hardware system design 220, the block is added, e.g., as shown in FIG. 3 where software component 1 has a solid border and is now added to embedded hardware system design 220, and the user may continue designing embedded hardware system design 220 by adding additional blocks 222 as desired. As an example, the user may now attempt to add software component N to embedded hardware system design 220 as a newly added block 228 in FIG. 3.

In a case where newly added block 228 is not compatible with embedded hardware system design 220, compatibility logic 216 is configured to cause design interface 214 to present a compatibility warning 230, e.g., as shown in FIG. 3, identifying the compatibility issue and which block(s) are not compatible with the newly added block. As an example, in FIG. 3, the newly added block software component N is not compatible with hardware component 1 as depicted in compatibility warning 230.

Recommendation logic 218 is configured to automatically determine one or more recommendations for alternative blocks in a case where compatibility logic 216 determines that a newly added block 228 is not compatible with embedded hardware system design 220. Recommendation logic 218 may be configured to run in the background without the user’s awareness in some embodiments. In some embodiments, recommendation logic 218 may utilize the block related compatibility information that was pre-downloaded or cached by web browser 212 in determining a recommendation. In some embodiments, recommendation logic 218 may be configured to communicate with corresponding recommendation logic 308 of server 300 to determine a recommendation. In some embodiments, recommendation logic 218 may be configured to communicate with recommendation logic 308 of server 300 to perform a recommendation determination for each newly added block 228 that fails the compatibility check of compatibility logic 216.

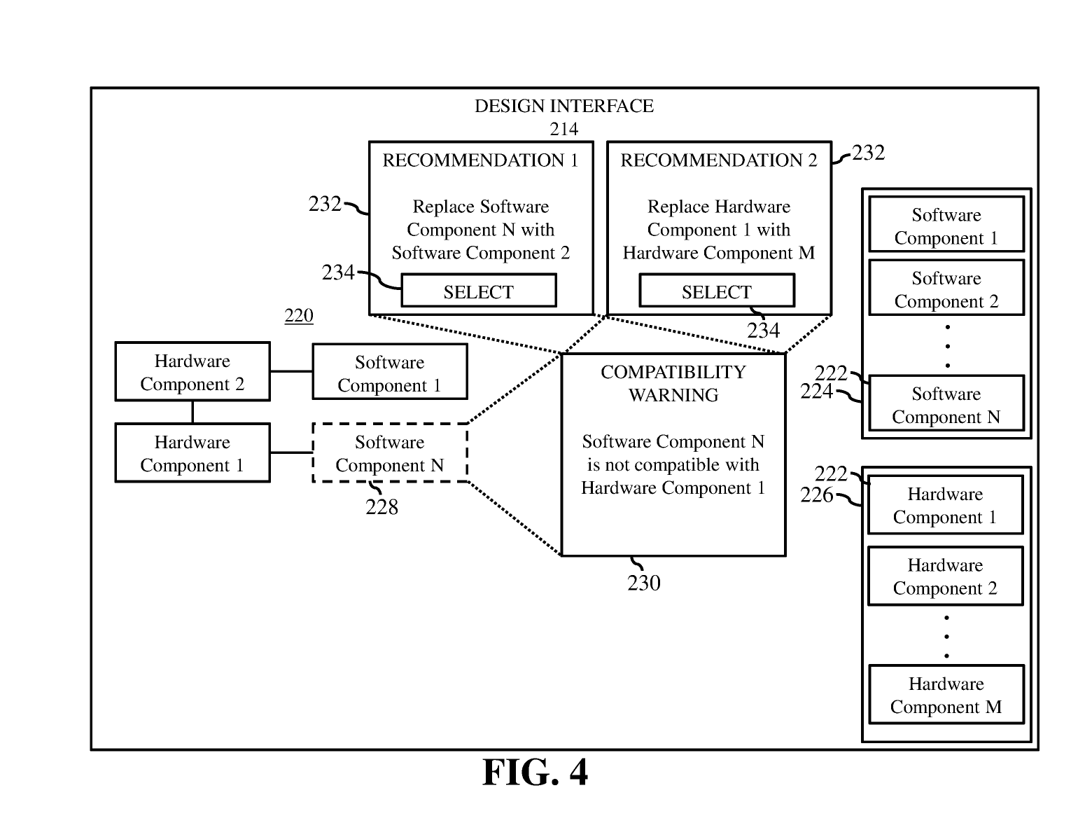

In a case where compatibility logic 216 determines that newly added block 228 is not compatible with embedded hardware system design 220, recommendation logic 218 is configured to cause design interface 214 to present one or more recommendations 232, e.g., recommendation 1 and recommendation 2 as shown in FIG. 4, identifying recommended options that the user may select to add or replace a block in embedded hardware system design 220 to achieve a compatible design. The recommendations 232 may each include an activatable element 234 that may be selected by the user, e.g., using input device 208 via design interface 214, to select a particular option. As an example, in FIG. 4, the newly added block 228, software component N, is not compatible with hardware component 1 as depicted in compatibility warning 230. Design interface 214 may present recommendations 232, e.g., recommendation 1 and recommendation 2 for selection. For example, recommendation 1 may suggest replacing software component N with software component 2 while recommendation 2 may suggest replacing hardware component 1 with hardware component M, each of which has been determined to be compatible in embedded hardware system design 220 by recommendation logic 218.

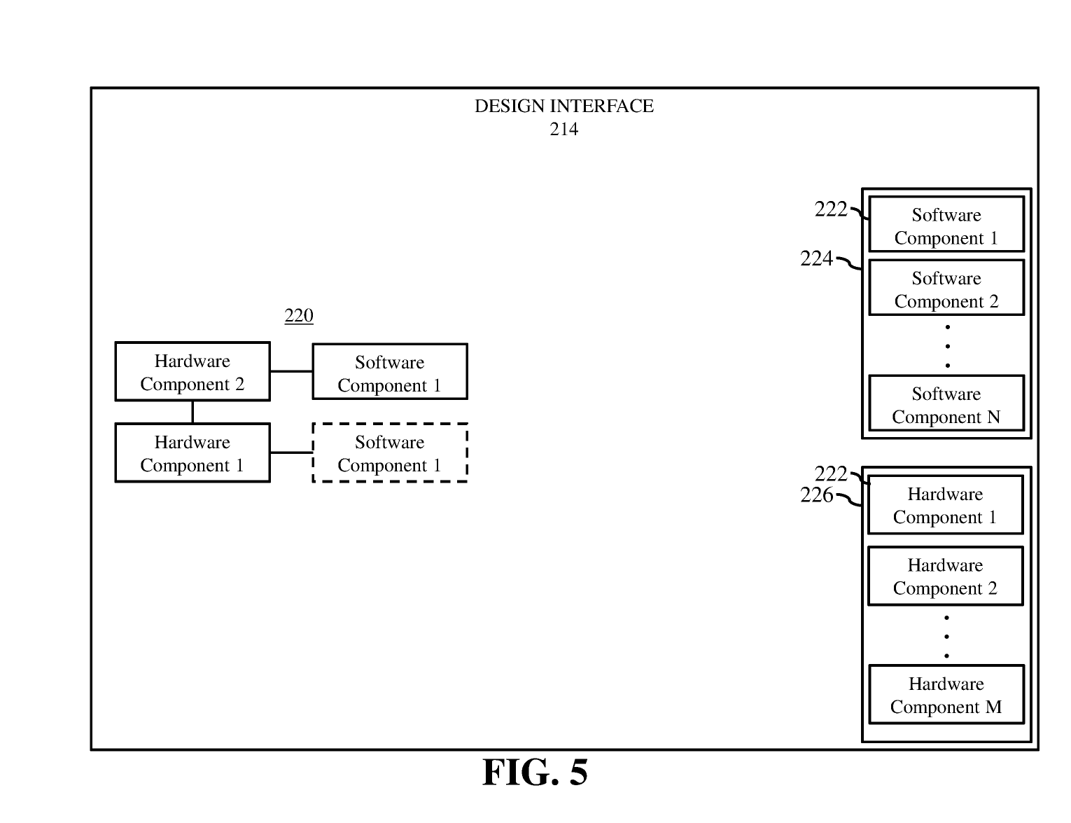

If the user selects recommendation 1, e.g., by selecting the corresponding activatable element 234, software component N is replaced by software component 2, e.g., as shown in FIG. 5.

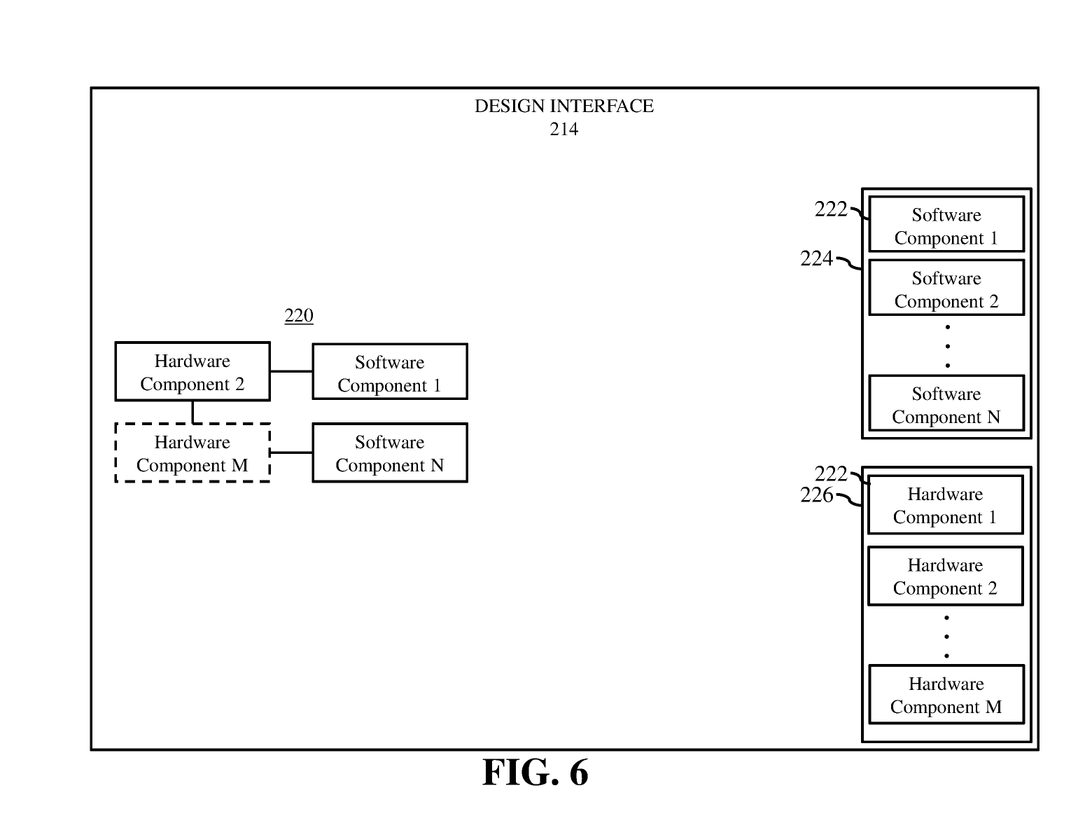

If the user alternatively selects recommendation 2, e.g., by selecting the corresponding activatable element 234, existing hardware component 1 of embedded hardware system design 220 is replaced by hardware component M and software component N is added to embedded hardware system design 220, e.g., as shown in FIG. 6.

In some embodiments, the user may also decline the recommendations 232 and simply remove the incompatible block 222. The user may then continue adding blocks 222 as usual, which will be checked for compatibility in real-time as described above.

In this manner, a user of design interface 214 may create an embedded hardware system design 220 that takes into account compatibility between various hardware and software components simply by selecting a corresponding block 222 to be added to the embedded hardware system design 220, receiving a notification in real-time if the newly added block 228 is not compatible, and receiving recommended alternatives from which to select for addition or replacement in the embedded hardware system design 220. All this is performed directly in the design interface 214 of a web browser 212 without the need to install separate software or hardware on the host device 200 and can be performed from any other host device 200 having a web browser 212 simply by logging into design interface 214 using the same credentials. In addition, the embedded hardware system design 220 may be shared to other individuals with access simply by having those individuals also log into design interface 214 via their own web browser 212 without the need to install additional software or hardware on their host device 200.

The components and use of server 300 in conjunction with design interface 214, compatibility logic 216 and recommendation logic 218 to perform compatibility checks and provide recommended options to design interface 214 for presentation to the user of host device 200 will now be described.

Server 300 comprises one or more processors 302, memory 30, compatibility logic 306, recommendation logic 308, component data store 312 and compatibility matrix 314.

Processor(s) 302 comprise, e.g., a processor, a microprocessor, a microcontroller, an application-specific integrated circuit (ASIC), a field-programmable gate array (FPGA), a graphics processing unit (GPU), a printed circuit board (PCB) or any other type of processing circuitry, as well as portions or combinations of such circuitry elements.

Memory 304 comprises, e.g., random access memory (RAM), read-only memory (ROM), flash memory or other types of memory, in any combination. The memory and other memories disclosed herein should be viewed as illustrative examples of what are more generally referred to as “processor-readable storage media” storing executable program code of one or more software programs.

Compatibility logic 306 is configured to cooperate with compatibility logic 216 to determine the compatibility of newly added block 228 to embedded hardware system design 220. As an example, compatibility logic 216 may submit a request to compatibility logic 306, e.g., via network 102, to determine the compatibility of newly added block 228 for a hardware component or software component. In some embodiments, the request may comprise information corresponding to embedded hardware system design 220, e.g., which blocks 222 are already included and in what design configuration. Compatibility logic 306 is configured to compatibility matrix 314 to obtain compatibility information about newly added block 228 and one or more of the other blocks 222 currently included in embedded hardware system design 220, e.g., depending on the design configuration.

Using the compatibility information for each block, compatibility logic 306 is configured to determine whether or not the newly added block 228 is compatible with the other blocks 222 currently included in embedded hardware system design 220 in the current design configuration.

In a case where the newly added block 228 is determined to be compatible, a response may be sent from compatibility logic 306 to compatibility logic 216 indicating that the newly added block 228 is compatible. In a case where the newly added block 228 is determined to not be compatible, a response may be sent from compatibility logic 306 to compatibility logic 216 indicating that the newly added block 228 is not compatible. For example, compatibility logic 306 may generate and transmit an alert to compatibility logic 216 including a detailed explanation of the compatibility warning which may be presented in design interface 214, e.g., as shown by compatibility warning 230 in FIG. 3.

In some embodiments, compatibility logic 306 may also trigger an execution of recommendation logic 308 to identify one or more recommendations 232 for submission to recommendation logic 218. In other embodiments, recommendation logic 308 may be configured to wait on a request from recommendation logic 218 before identifying one or more recommendations 232.

Recommendation logic 308 is configured to cooperate with recommendation logic 218 to determine recommendations in response to newly added block 228 being found incompatible with embedded hardware system design 220. As an example, recommendation logic 218 may submit a request to recommendation logic 308, e.g., via network 102, to determine the recommendation options for replacing newly added block 228 or another block 222 with another hardware component or software component in a design configuration that makes embedded hardware system design 220 internally compatible with itself.

In some embodiments, the request may comprise information corresponding to embedded hardware system design 220, e.g., which blocks 222 are already included, the newly added block 228 and what design configuration all of the blocks 222 included in embedded hardware system design 220 are in. Recommendation logic 308 is configured to access component data store 312, compatibility matrix 314 or both, to obtain compatibility information about newly added block 228 and one or more of the other blocks 222 currently included in embedded hardware system design 220, e.g., depending on the design configuration. Recommendation logic 308 is configured to identify one or more recommendations 232 for modifying embedded hardware system design 220 by replacing newly added block 228 or one of the other blocks 222 in a manner that ensures that embedded hardware system design 220 is internally compatible. As an example, if any compatibility issues are found, recommendation logic 308 may generate and transmit recommendations to recommendation logic 218, such as, e.g., upgrading a driver, increasing RAM, switching to a newer MCU or operating system or any other recommendation, based on information found in component data store 312, compatibility matrix 314 or both, which may be presented in design interface 214, e.g., as shown by recommendations 232 in FIG. 4.

Component data store 312 comprises information about each hardware and software component that may be included in embedded hardware system design 220 as a block 222 including, e.g., connections, capabilities, inputs, outputs, power requirements, minimum and recommended system requirements for software and hardware components, drivers, firmware, etc. The information in component data store 312 is utilized by server 300 to determine a compatibility between various available blocks 222. The compatibility determinations may be stored in compatibility matrix 314 for ease of access and quick reference. Server 300 is configured to update component data store 312 based on data provided by software vendors, hardware manufacturers and industry standards organizations, e.g., via network 102. For example, various software and hardware components may be added, removed or updated in component data store 312 periodically, continuously, or in any other manner.

Compatibility matrix 314 is generated by server 300 based on the information found in component data store 312. Compatibility matrix 314 comprises information about specific compatibility interactions between various component blocks 222 in an easy to reference format. This enables rapid compatibility determinations for the known blocks 222 that may be utilized in creating embedded hardware system design 220. In some embodiments, for example, compatibility matrix 314 may comprise minimum and recommended system requirements for various software applications and an indication of which hardware components are or are not compatible with particular software components based on this information. Similarly, compatibility matrix 314 may comprise indications of which hardware components are compatible with each other and in what configurations, e.g., based on the information contained in component data store 312. In an embodiment, server 300 may utilize a rule-based engine to determine whether the hardware and software configurations meet the minimum or recommended requirements for a specific software application or hardware component.

In some embodiments, component data store 312 may comprise compatibility matrix 314, e.g., compatibility determinations may be made and stored along with the information about each hardware or software component. In some embodiments, the compatibility matrix may be stored separately on server 300 from component data store 312 where, for example, each time a hardware component or software component is added, removed, or updated, compatibility matrix 314 may also be updated with corresponding compatibility determinations. In other embodiments, compatibility may be determined based on the information in component data store 312 without first collating the information into a separate compatibility matrix 314.

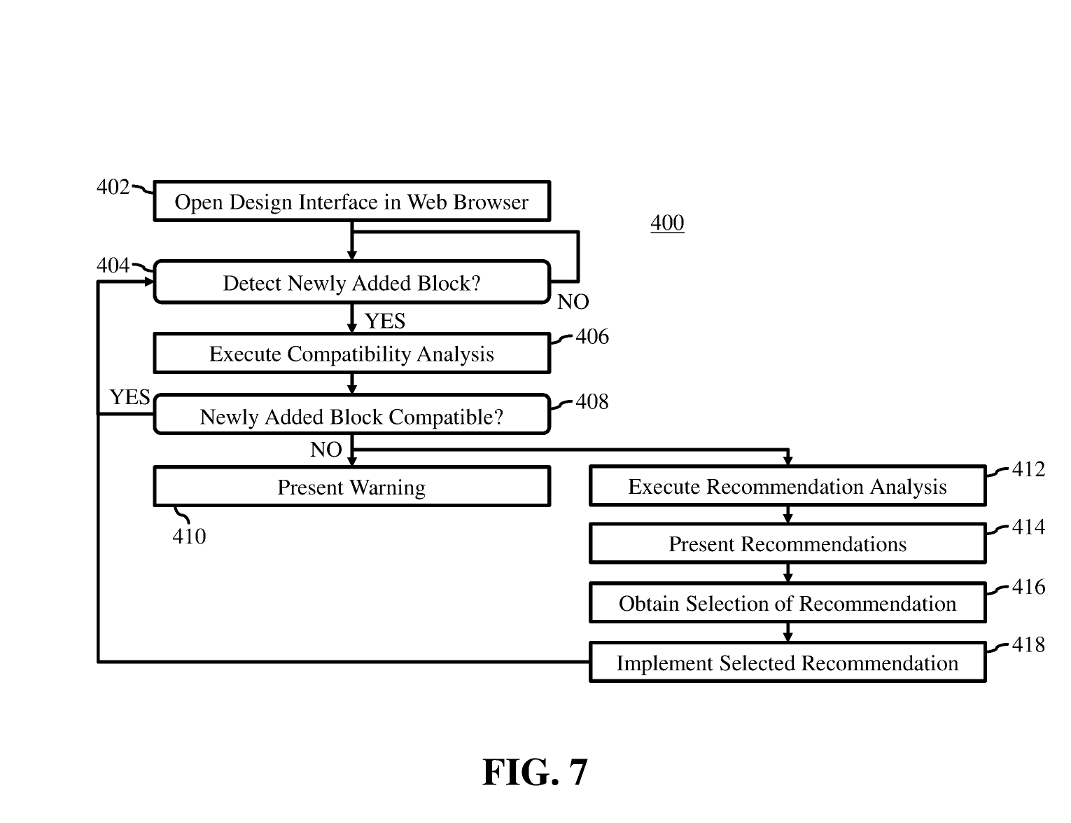

In some embodiments, design interface 214 may be configured to perform a design logic process 400. FIG. 7 is a diagram of a flowchart of an example design logic process 400 in an embodiment. Process 400 may be implemented at least in part by host device 200, server 300 or any combination thereof. Process 400 may include one or more operations, actions, or functions as illustrated by one or more of blocks 402, 404, 406, 408, 410, 412, 414, 416 and 418. Although illustrated as discrete blocks, various blocks may be divided into additional blocks, combined into fewer blocks, eliminated, performed in different order, or performed in parallel, depending on the desired implementation. Similarly, additional blocks may be added. The description of FIG. 7 may refer to elements shown in FIGS. 1-6.

Process 400 begins at block 402. At block 402, host device 200 opens design interface 214 in web browser 212, e.g., in response to a user input. For example, the user may open web browser 212 and select a bookmark or type in a uniform resource locator (URL) corresponding to design interface 214. Server 300 may receive a request for content from host device 200 based on the bookmark or URL and transmit a response containing design interface 214 to host device 200 based on the request. The user may also be requested to login to design interface 214, e.g., using user credentials, including corresponding authentication communications between host device 200 and server 300 via web browser 212.

At block 404, design interface 214 determines whether a newly added block 228 has been added to an embedded hardware system design 220. For example, the user may click and drag a block 222 from software components 224 or hardware components 226 to embedded hardware system design 220 and make any appropriate connections. The user may alternatively add a newly added block 228 in any other manner within design interface 214. If no newly added block 228 has been detected, the process returns to block 404, e.g., continuously cycles and monitors embedded hardware system design 220 for a newly added block 222. If a newly added block 228 has been detected, the process proceeds to block 406.

At block 406, compatibility logic 216 executes a compatibility analysis on the newly added block 228 and the other components of embedded hardware system design 220, e.g., as described above. For example, compatibility logic 216 may make a compatibility determination based on information cached within web browser 212 or query compatibility logic 306 of server 300 to perform a compatibility analysis using component data store 312, compatibility matrix 314 or both.

At block 408, compatibility logic 216 determines whether or not the newly added block 228 is compatible with embedded hardware system design 220 based on a result of the compatibility analysis. If newly added block 228 is compatible, the process returns to block 404. If the newly added block 228 is not compatible, the process proceeds to blocks 410 and 412. In some embodiments, block 412 may follow block 410 instead of being in parallel with block 410 as shown in FIG. 7.

At block 410, design interface 214 presents a compatibility warning 230 to the user, e.g., as shown in FIG. 3.

At block 412, recommendation logic 218 executes a recommendation analysis on the newly added block 228 and the other components of embedded hardware system design 220, e.g., as described above. For example, recommendation logic 218 may generate one or more recommendations based on information cached within web browser 212, query recommendation logic 308 of server 300 to perform a recommendation analysis using component data store 312 and compatibility matrix 314, or both. In some embodiments, compatibility logic 306 of server 300 may trigger recommendation logic 308 of server 300 to perform the recommendation analysis based on a determination that newly added block 228 is not compatible with embedded hardware system design 220 without waiting for further instruction from recommendation logic 218. Recommendations generated by recommendation logic 308 are transmitted to recommendation logic 218 for presentation to the user in design interface 214.

At block 414, design interface 214 presents one or more recommendations 232 to the user, e.g., as shown in FIG. 4.

At block 416, design interface 214 obtains a selection by the user of one of the recommendations 232, e.g., by selection of an activatable element 234 in the corresponding recommendation 232 via input device 208. The method then proceeds to block 418. In some embodiments, the user may not select one of the recommendations, e.g., the user may just delete the newly added block 228. In such a case, the process may return from block 414 to block 404 and continue monitoring for newly added blocks.

At block 418, design interface 214 implements the selected recommendation, e.g., as shown in FIG. 5 or FIG. 6 depending on which recommendation is selected. The process then returns to block 404.

While process 400 is described with respect to design interface 214, any other circuitry or component may alternatively perform process 400.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Examples

Example 1: A design system comprising: a server in communication with a host device, the server being configured to: obtain a compatibility request to perform a compatibility analysis from a design interface presented to a user of the host device by a web browser of the host device, the compatibility request comprising design information corresponding to a plurality of blocks of an embedded hardware system design; execute the compatibility analysis based on the design information and a compatibility matrix comprising compatibility information for each of the plurality of blocks; determine that a given block of the plurality of blocks is not compatible with at least one other block of the plurality of blocks based on the compatibility analysis; and transmit a response to the host device, the response comprising an indication that the given block is not compatible with the at least one other block.

Example 2: The design system of Example 1, wherein the server is further configured to: determine a recommendation based on the determination that the given block is not compatible with the at least one other block, the recommendation comprising an alternative block that is recommended to replace at least one corresponding block of the plurality of blocks; and transmit the recommendation to the host device for presentation in the design interface.

Example 3: The design system of any one of Examples 1 to 2, wherein the server is further configured to: receive a content request comprising a uniform resource locator corresponding to the design interface from the web browser of the host device; retrieve the design interface; and transmit the design interface to the web browser of the host device for presentation in the web browser.

Example 4: The design system of any one of Examples 1 to 3, wherein the server is further configured to: receive, from the web browser, user credentials of a user of the host device; determine that the user credentials correspond to the embedded hardware system design; and transmit the embedded hardware system design to the web browser as part of the design interface.

Example 5: The design system of any one of Examples 1 to 4, wherein the given block comprises a newly added block to the embedded hardware system design.

Example 6: The design system of any one of Examples 1 to 5, wherein the compatibility matrix comprises compatibility information on a standard set of blocks comprising the plurality of blocks, the design interface being configured to present the user of the host device with the standard set of blocks each of which is selectable for addition to the embedded hardware system design.

Example 7: The design system of any one of Examples 1 to 6, wherein the standard set of blocks comprises hardware blocks and software blocks.

Example 8: A method comprising: obtaining a compatibility request to perform a compatibility analysis from a design interface presented to a user of a host device by a web browser of the host device, the compatibility request comprising design information corresponding to a plurality of blocks of an embedded hardware system design; executing the compatibility analysis based on the design information and a compatibility matrix comprising compatibility information for each of the plurality of blocks; determining that a given block of the plurality of blocks is not compatible with at least one other block of the plurality of blocks based on the compatibility analysis; and transmitting a response to the host device, the response comprising an indication that the given block is not compatible with the at least one other block.

Example 9: The method of Example 8, wherein the method further comprises: determining a recommendation based on the determination that the given block is not compatible with the at least one other block, the recommendation comprising an alternative block that is recommended to replace at least one corresponding block of the plurality of blocks; and transmitting the recommendation to the host device for presentation in the design interface.

Example 10: The method of any one of Examples 8 to 9, wherein the method further comprises: receiving a content request comprising a uniform resource locator corresponding to the design interface from the web browser of the host device; retrieving the design interface; and transmitting the design interface to the web browser of the host device for presentation in the web browser.

Example 11: The method of any one of Examples 8 to 10, wherein the method further comprises: receiving, from the web browser, user credentials of a user of the host device; determining that the user credentials correspond to the embedded hardware system design; and transmitting the embedded hardware system design to the web browser as part of the design interface.

Example 12: The method of any one of Examples 8 to 11, wherein the given block comprises a newly added block to the embedded hardware system design.

Example 13: The method of any one of Examples 8 to 12, wherein the compatibility matrix comprises compatibility information on a standard set of blocks comprising the plurality of blocks, the design interface being configured to present the user of the host device with the standard set of blocks each of which is selectable for addition to the embedded hardware system design.

Example 14: The method of any one of Examples 8 to 13, wherein the standard set of blocks comprises hardware blocks and software blocks.

Example 15: An apparatus comprising: a display device; an input device; a user interface configured for presentation on the display device, the user interface comprising a web browser, the web browser being configured to present a design interface comprising an embedded hardware system design to a user of the apparatus, the web browser being configured to: determine that a given block has been added to a plurality of blocks of the embedded hardware system design; automatically submit a compatibility request to a server to perform a compatibility analysis, the compatibility request comprising design information corresponding to the plurality of blocks of the embedded hardware system design; obtain a response from the server comprising an indication that the given block is not compatible with at least one other block of the plurality of blocks of the embedded hardware system design; and present, in the design interface, a compatibility warning indicating that the given block is not compatible with the at least one other block of the plurality of blocks of the embedded hardware system design.

Example 16: The apparatus of Example 15, wherein the web browser is further configured to: obtain a recommendation from the server, the recommendation comprising an alternative block that is recommended to replace at least one corresponding block of the plurality of blocks; and present, in the design interface, the recommendation.

Example 17: The apparatus of any one of Examples 15 to 16, wherein: the recommendation comprises an activatable element; the web browser is further configured to: determine that the activatable element has been selected by the user; and replace the at least one corresponding block of the plurality of blocks with the alternative block in the embedded hardware system design.

Example 18: The apparatus of any one of Examples 15 to 17, wherein the at least one corresponding block of the plurality of blocks comprises one of the given block and the at least one other block of the plurality of blocks of the embedded hardware system design.

Example 19: The apparatus of any one of Examples 15 to 18, wherein the web browser is further configured to: transmit a content request comprising a uniform resource locator corresponding to the design interface to the server; receive, from the server, content corresponding to the design interface; and present the design interface in the web browser based on the received content.

Example 20: The apparatus of any one of Examples 15 to 19, wherein: the design interface comprises a standard set of blocks comprising the plurality of blocks; the design interface is configured to present the standard set of blocks to the user, each of which is selectable for addition to the embedded hardware system design; and the server comprises a compatibility matrix comprising compatibility information for each block of the standard set of blocks, the server being configured to perform the compatibility analysis based on the compatibility matrix.

The terminology used herein is for the purpose of describing particular embodiments only and is not intended to be limiting of the invention. As used herein, the singular forms "a", "an" and "the" are intended to include the plural forms as well, unless the context clearly indicates otherwise. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present invention have been presented for purposes of illustration and description but are not intended to be exhaustive or limited to the invention in the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A design system comprising:
a server in communication with a host device, the server being configured to:
obtain a compatibility request to perform a compatibility analysis from a design interface presented to a user of the host device by a web browser of the host device, the compatibility request comprising design information corresponding to a plurality of blocks of an embedded hardware system design;
execute the compatibility analysis based on the design information and a compatibility matrix comprising compatibility information for each of the plurality of blocks;
determine that a given block of the plurality of blocks is not compatible with at least one other block of the plurality of blocks based on the compatibility analysis; and
transmit a response to the host device, the response comprising an indication that the given block is not compatible with the at least one other block.

2. The design system of claim 1, wherein the server is further configured to:
determine a recommendation based on the determination that the given block is not compatible with the at least one other block, the recommendation comprising an alternative block that is recommended to replace at least one corresponding block of the plurality of blocks; and
transmit the recommendation to the host device for presentation in the design interface.

3. The design system of claim 1, wherein the server is further configured to:
receive a content request comprising a uniform resource locator corresponding to the design interface from the web browser of the host device;
retrieve the design interface; and
transmit the design interface to the web browser of the host device for presentation in the web browser.

4. The design system of claim 3, wherein the server is further configured to:
receive, from the web browser, user credentials of a user of the host device;
determine that the user credentials correspond to the embedded hardware system design; and
transmit the embedded hardware system design to the web browser as part of the design interface.

5. The design system of claim 1, wherein the given block comprises a newly added block to the embedded hardware system design.

6. The design system of claim 1, wherein the compatibility matrix comprises compatibility information on a standard set of blocks comprising the plurality of blocks, the design interface being configured to present the user of the host device with the standard set of blocks each of which is selectable for addition to the embedded hardware system design.

7. The design system of claim 6, wherein the standard set of blocks comprises hardware blocks and software blocks.

8. A method comprising:
obtaining a compatibility request to perform a compatibility analysis from a design interface presented to a user of a host device by a web browser of the host device, the compatibility request comprising design information corresponding to a plurality of blocks of an embedded hardware system design;
executing the compatibility analysis based on the design information and a compatibility matrix comprising compatibility information for each of the plurality of blocks;
determining that a given block of the plurality of blocks is not compatible with at least one other block of the plurality of blocks based on the compatibility analysis; and
transmitting a response to the host device, the response comprising an indication that the given block is not compatible with the at least one other block.

9. The method of claim 8, wherein the method further comprises:
determining a recommendation based on the determination that the given block is not compatible with the at least one other block, the recommendation comprising an alternative block that is recommended to replace at least one corresponding block of the plurality of blocks; and
transmitting the recommendation to the host device for presentation in the design interface.

10. The method of claim 8, wherein the method further comprises:
receiving a content request comprising a uniform resource locator corresponding to the design interface from the web browser of the host device;
retrieving the design interface; and
transmitting the design interface to the web browser of the host device for presentation in the web browser.

11. The method of claim 10, wherein the method further comprises:
receiving, from the web browser, user credentials of a user of the host device;
determining that the user credentials correspond to the embedded hardware system design; and
transmitting the embedded hardware system design to the web browser as part of the design interface.

12. The method of claim 8, wherein the given block comprises a newly added block to the embedded hardware system design.

13. The method of claim 8, wherein the compatibility matrix comprises compatibility information on a standard set of blocks comprising the plurality of blocks, the design interface being configured to present the user of the host device with the standard set of blocks each of which is selectable for addition to the embedded hardware system design.

14. The method of claim 13, wherein the standard set of blocks comprises hardware blocks and software blocks.

15. An apparatus comprising:
a display device;
an input device;
a user interface configured for presentation on the display device, the user interface comprising a web browser, the web browser being configured to present a design interface comprising an embedded hardware system design to a user of the apparatus, the web browser being configured to:
determine that a given block has been added to a plurality of blocks of the embedded hardware system design;
automatically submit a compatibility request to a server to perform a compatibility analysis, the compatibility request comprising design information corresponding to the plurality of blocks of the embedded hardware system design;
obtain a response from the server comprising an indication that the given block is not compatible with at least one other block of the plurality of blocks of the embedded hardware system design; and
present, in the design interface, a compatibility warning indicating that the given block is not compatible with the at least one other block of the plurality of blocks of the embedded hardware system design.

16. The apparatus of claim 15, wherein the web browser is further configured to:
obtain a recommendation from the server, the recommendation comprising an alternative block that is recommended to replace at least one corresponding block of the plurality of blocks; and
present, in the design interface, the recommendation.

17. The apparatus of claim 16, wherein:
the recommendation comprises an activatable element;
the web browser is further configured to:
determine that the activatable element has been selected by the user; and
replace the at least one corresponding block of the plurality of blocks with the alternative block in the embedded hardware system design.

18. The apparatus of claim 17, wherein the at least one corresponding block of the plurality of blocks comprises one of the given block and the at least one other block of the plurality of blocks of the embedded hardware system design.

19. The apparatus of claim 15, wherein the web browser is further configured to:
transmit a content request comprising a uniform resource locator corresponding to the design interface to the server;
receive, from the server, content corresponding to the design interface; and
present the design interface in the web browser based on the received content.

20. The apparatus of claim 15, wherein:
the design interface comprises a standard set of blocks comprising the plurality of blocks;
the design interface is configured to present the standard set of blocks to the user, each of which is selectable for addition to the embedded hardware system design; and
the server comprises a compatibility matrix comprising compatibility information for each block of the standard set of blocks, the server being configured to perform the compatibility analysis based on the compatibility matrix.
